(19) United States
(12) Patent Application Publication
(10) Pub. No.: US 2025/0336219 A1
(43) Pub. Date: Oct. 30, 2025

(54) THREE-DIMENSIONAL OBJECT IDENTIFICATION AND SEGMENTATION

(71) Applicant: Varjo Technologies Oy, Helsinki (FI)

(72) Inventor: Ville Timonen, Helsinki (FI)

(73) Assignee: Varjo Technologies Oy, Helsinki (FI)

(21) Appl. No.: 18/644,772

(22) Filed: Apr. 24, 2024

(51) Int. Cl. G06V 20/64; G06T 7/70; G06T 19/00; G06V 20/20

(52) U.S. Cl. CPC G06V 20/647; G06T 7/70; G06T 19/006; G06V 20/20; G06T 2207/10016; G06T 2207/30244

(57) ABSTRACT

A computer-implemented method including: capturing at least one image using at least one video-see-through camera of a display apparatus; determining a pose of the at least one VST camera from which the at least one image is captured; identifying image segments in the at least one image that represent different real-world objects in a real-world environment; generating a set of two-dimensional (2D) image masks corresponding to the image segments representing the different real-world objects, wherein a given 2D image mask corresponds to a given real-world object; and digitally projecting the 2D image masks of the set onto a three-dimensional (3D) model of the real-world environment, from a perspective of the pose of the at least one VST camera, to determine at least one of: 3D shapes, 3D locations in the real-world environment, 3D orientations, 3D sizes, of the different real-world objects.

### TECHNICAL FIELD

The present disclosure relates to a computer-implemented method of identification and segmentation of three-dimensional objects in video see-through (VST). Moreover, the present disclosure relates to a system for three-dimensional object identification and segmentation.

### BACKGROUND

In the domain of extended reality (XR), virtual reality (VR), augmented reality (AR), and mixed reality (MR) head-mounted displays, one persistent problem is how to accurately identify and segment different real-world objects within the visual input. The lack of precision in identifying and segmenting different real-world objects within the visual input leads to issues with realism, inaccurate tagging, recognizing of the real-world objects, and effectiveness of the mixed reality experience.

Traditional methods to address tagging and recognizing real-world objects in virtual environments often include manual processes that are time-consuming and prone to errors. Users need to manually point and outline objects in the physical space, leading to the selection of objects, inaccurate shapes and inefficient object selection. Additionally, detecting individual objects from 3D models of the environment can be challenging, as everything in the room is often fused into a single mesh. Furthermore, a two-dimensional (2D) image segmentation is not sufficient for accurate object recognition in virtual environments and may lead to major inaccuracy issues, such as the inability to differentiate between similar objects of different sizes at different distances and the confusion between real objects and images of objects that hinders the effectiveness in accurately identifying and tagging real-world objects.

Therefore, in the light of the foregoing discussion, there exists a need to overcome the aforementioned drawbacks.

### SUMMARY

The aim of the present disclosure is to provide a computer-implemented method for the identification and segmentation of three-dimensional objects in video-see-through (VST). The aim of the present disclosure is achieved by a computer-implemented method, as defined in the appended independent claims, which involves capturing images using video-see-through (VST) cameras, determining the pose of the cameras, identifying image segments representing different real-world objects, generating 2D image masks for these segments, and digitally projecting the masks onto a 3D model of the real-world environment to determine various characteristics of the objects. Advantageous features and additional implementations are set out in the appended dependent claims.

Embodiments of the present disclosure substantially eliminate or at least partially address the aforementioned problems in the prior art and enable the identification and segmentation of three-dimensional (3D) objects in video-see-through (VST).

Throughout the description and claims of this specification, the words “comprise”, “include”, “have”, and “contain” and variations of these words, for example, “comprising” and “comprises”, mean “including but not limited to”, and do not exclude other components, items, integers, or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a computer-implemented method for identification and segmentation of a three-dimensional (3D) object in video-see through (VST), in accordance with an embodiment of the present disclosure;

FIG. 2 is an illustration of a block diagram of a system configured for identification and segmentation of a three-dimensional (3D) object in video-see through (VST), in accordance with an embodiment of the present disclosure;

FIG. 3 is an illustration of an exemplary diagram an exemplary diagram of events in the system, in accordance with an embodiment of the present disclosure;

FIG. 4 is an illustration of an exemplary diagram of a three-dimensional (3D) object fusion, in accordance with an embodiment of the present disclosure;

FIG. 5A is an illustration of an exemplary diagram of a Cloud-based architecture for identification and segmentation of a three-dimensional (3D) object in video-see through (VST), in accordance with an embodiment of the present disclosure; and

FIG. 5B is an illustration of another exemplary diagram of a Cloud-based architecture for identification and segmentation of a three-dimensional (3D) object in video-see through (VST), in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a computer-implemented method comprising:
capturing at least one image using at least one video-see-through (VST) camera of a display apparatus;
determining a pose of the at least one VST camera from which the at least one image is captured;
identifying image segments in the at least one image that represent different real-world objects in a real-world environment;
generating a set of two-dimensional (2D) image masks corresponding to the image segments representing the different real-world objects, wherein a given 2D image mask corresponds to a given real-world object; and
digitally projecting the 2D image masks of the set onto a three-dimensional (3D) model of the real-world environment, from a perspective of the pose of the at least one VST camera, to determine at least one of: 3D shapes, 3D locations in the real-world environment, 3D orientations, 3D sizes, of the different real-world objects.

In a second aspect, the present disclosure provides a system comprising:
at least one video-see-through (VST) camera arranged on a display apparatus;
a pose-tracking means; and
at least one processor configured to:
   capture at least one image using the at least one VST camera;
   determine a pose of the at least one VST camera from which the at least one image is captured, using the pose-tracking means;
   identify image segments in the at least one image that represent different real-world objects in a real-world environment;
   generate a set of two-dimensional (2D) image masks corresponding to the image segments representing the different real-world objects, wherein a given 2D image mask corresponds to a given real-world object; and
   digitally project the 2D image masks of the set onto a three-dimensional (3D) model of the real-world environment, from a perspective of the pose of the at least one VST camera, to determine at least one of: 3D shapes, 3D locations in the real-world environment, 3D orientations, 3D sizes, of the different real-world objects.

The present disclosure provides the aforementioned computer-implemented method and a system for the identification and segmentation of three-dimensional objects in video-see-through (VST). By capturing images and generating corresponding 2D image masks, the computer-implemented method allows for precise delineation of object boundaries. Furthermore, digitally projecting the 2D image masks onto a 3D model enables the determination of various characteristics of the objects, such as shapes, locations, orientations, and sizes of the object in a three-dimensional space. As a result, the computer-implemented method facilitates an enhanced spatial understanding and interaction within mixed-reality applications, thereby enhancing user experiences and enabling a wide range of immersive computing applications. In addition, the computer-implemented method is used to identify different real-world objects accurately and efficiently in a given environment using video-see-through (VST) cameras.

Throughout the present disclosure, the term “at least one video-see-through (VST) camera” refers to an image-capturing device that is arranged to face the real-world environment in which the display apparatus is present. The capturing of the at least one image using the at least one VST camera facilitates augmented reality (AR) experiences by providing a live video feed of the physical environment, which can then be augmented with virtual objects, information, or graphics. As a result, a seamless alignment between the captured images and the displayed augmented content can be ensured in order to interact with digital content overlaid onto the real-world surroundings, thereby creating immersive and engaging experiences.

Throughout the present disclosure, the term “display apparatus” refers to a specialized equipment that is capable of at least displaying a visual information. It will be appreciated that the term “display apparatus” encompasses a head-mounted display (HMD) device. The term “head-mounted display” device refers to a specialized equipment that is configured to present an extended-reality (XR) environment to a user when said HMD device, in operation, is worn by said user on his/her head. The HMD device is implemented, for example, as an XR headset, a pair of XR glasses, and the like, that is operable to display a visual scene of the XR environment to the user.

Throughout the present disclosure, the term “pose” of the at least one VST camera encompasses both the position and orientation of the at least one VST camera from which the image is captured. The plurality of images that are captured from the different poses of the at least one VST camera is used to provide a comprehensive understanding of the real-world object in order to improve the robustness and reliability of image processing and 3D modelling while considering possible occlusions and variations in object appearance from different angles. The technical effect of determining the pose of the at least one VST camera from which the at least one image is to enable accurate spatial awareness and alignment between the virtual and real-world environment.

Throughout the present disclosure, the term “image segments” refers to distinct regions or areas within a digital image that has been separated based on certain visual characteristics, such as color, texture, brightness, or other features. Each segment typically represents a different object, or a part of an object, or an area within the image. The image segments are identified in the at least one image that represents different real-world objects in a real-world environment. In this regard, the term “real-world object” encompasses a physical object, a part of the physical object, as well as a shadow cast by the physical object or the part of the physical object. The real object could be a living object (e.g., a human, a pet, a tree, and the like) or a non-living object (e.g., the sky, a building, a road, a toy, a poster, a letter box, and the like). By utilizing the plurality of images captured from different poses of the at least one VST camera, the method allows for the creation of more accurate and detailed 3D models of real-world objects in the real-work environment. The identification of the image segments is performed to allow further analysis, understanding, and interaction with the different real-world objects within the environment. In an implementation, computer vision techniques, including segmentation algorithms, can be used for analyzing the visual information in the image, grouping pixels or regions based on visual similarities such as color, texture, and shapes for distinguishing different real-world objects within the image. The technical effect of identifying image segments in the at least one image that represents different real-world objects in a real-world environment is to provide an accurate identification of real-world objects, allowing for more precise alignment of virtual objects in an augmented reality environment, resulting in a more immersive and realistic experience.

Throughout the present disclosure, the term “two-dimensional (2D) image masks” refers to digital layers or masks within images that isolate specific real-world objects. In other words, the 2D image mask corresponds to a given real-world object. Additionally, each of the 2D masks represents a specific object within the image, allowing for the segmentation of the image into different areas based on the presence of different real-world objects. In an implementation, the set of 2D image masks is generated using image processing techniques such as object detection, segmentation, and edge detection. The technical effect of generating the set of 2D image masks provides a detailed understanding of the structure and spatial relationships of the real-world objects within the image to allow precise manipulation and interaction with both virtual and real-world elements, leading to more accurate and immersive mixed-reality experiences.

Throughout the present disclosure, the term “three-dimensional (3D) model” refers to a 3D model of the second real-world object representing the 3D shape, size, and the orientation of the second real-world object. The digital projection of the 2D image masks of the set onto the 3D model of the real-world environment involves mapping the 2D masks onto a 3D model to represent the real-world objects in the actual spatial configuration of the real-world objects. Moreover, the 3D model is in the form of at least one of: a 3D polygonal mesh, a 3D point cloud, a 3D surface cloud, a voxel-based model, a parametric model, a 3D grid, a 3D hierarchical grid, a bounding volume hierarchy. The 3D polygonal mesh could be a 3D triangular mesh, a 3D quadrilateral mesh, or similar. Therefore, by projecting the 2D masks onto a 3D model, the system can determine various properties of the real-world objects, such as the 3D shapes, 3D locations, 3D orientations, and 3D sizes of the real-world objects. This information is essential for correctly aligning virtual and real-world elements, enabling seamless interaction and manipulation within the mixed-reality environment. Optionally, the method further includes processing a plurality of previously captured images of the real-world environment to generate the 3D model of the real-world environment. Moreover, the pre-generated 3D model can be stored and accessed from a data repository. As a result, the technical effect of digitally projecting the 2D image masks onto the 3D model provides a precise and accurate representation of the real-world environment to allow an improved spatial awareness and interaction within the mixed-reality environment.

Optionally, the at least one image comprises a plurality of images that are captured from different poses of the at least one VST camera, the method further comprising:
determining whether at least a subset of the plurality of images have image segments that represent a given real-world object, based on a 3D location of the given real-world object in the real-world environment;
when it is determined that at least the subset of the plurality of images have the image segments that represent the given real-world object, fusing together the image segments that represent the given real-world object to generate a 3D model of the given real-world object.

In an implementation, the at least one VST camera captures the plurality of images from different angles or positions around the real-world environment. After that, the captured plurality of images is used to determine whether the at least a subset of the plurality of images has image segments that represent a given real-world object, based on a 3D location of the given real-world object in the real-world environment. Furthermore, the captured plurality of images is also used to determine whether the at least a subset of the plurality of images has image segments that represent a given real-world object, based on at least one of: a 3D shape, a 3D orientation, a 3D size of the given real-world object. Finally, by determining that at least the subset of the plurality of images has the image segments that represent the given real-world object, the image segments that represent the given real-world object are fused together to generate a 3D model of the given real-world object. The technical effect of capturing the plurality of images from different angles and then fusing the relevant image segments is used to provide an accurate and realistic 3D model of the real-world objects with an enhanced depth perception and understanding of the spatial relationships between objects in the real-world environment. As a result, the method is used to provide an enhanced augmented reality experiences and improved object recognition and tracking capabilities to the users.

Optionally, the method further comprises utilizing the 3D model of the given real-world object to perform at least one of:
superimposing a virtual object on the given real-world object when generating a mixed-reality image,
embedding a virtual object relative to the given real-world object when generating the mixed-reality image,
applying a depth-based occlusion effect when generating the mixed-reality image,
inpainting pixels when the given real-world object has a self-occluding geometry and is being dis-occluded in the mixed-reality image,
auditing real-world objects in the real-world environment,
simulating a virtual collision of the given real-world object with at least one virtual object in a sequence of mixed-reality images.

Throughout the present disclosure, the term “virtual object” refers to a computer-generated object (namely, a digital object). Examples of virtual objects may include, but are not limited to, virtual navigation tools (such as maps and direction signs), virtual gadgets (such as calculators and computers), virtual messages (such as instant messages and chat conversations), virtual entities (such as people and animals), virtual entertainment media (such as paintings and videos), virtual vehicles or parts (such as cars and cockpits), and virtual information (such as news, announcements, and data). The superimposing of the virtual object on the given real-world object when generating a mixed-reality image is used to provide a seamless integration of the virtual content with real-world objects, providing an immersive and interactive experience. In an implementation, a 3D virtual object may be superimposed on a 3D geometry of a real-world object. For example, a repair person wears an XR (extended reality) head-mounted display (HMD) device, allowing the repair person to view, detect, and highlight relevant real-world objects in the virtual environment, such as parts that need replacement or adjustment. Additionally, a set of instructions for the repair person can be provided through the VST. Moreover, the superimposition of the virtual object on the given real-world object allows for depth-based occlusion and disocclusion, providing accurate and enhanced knowledge of the 3D geometry of the real-world object. Additionally, such superimposition can also be used to measure and indicate the size, or the total area covered by the real-world objects in the room. In another example, if a user views a painting, the method is used to identify the painting and overlay information, such as the name of the artist, the year in which the painting was painted, and the like. As a result, the user's experience is improved by providing an additional information about the real-world objects that are viewed in the virtual reality environment. Additionally, the user can point towards a real-world object by highlighting it through a gaze or a controller to allow precise placement of the virtual objects either on or near the real-world object, creating a more seamless and integrated mixed-reality experience. Furthermore, a visual anchoring of the real-world objects is used to synchronize the virtual objects with the user's view of the real-world to ensure precise alignment of the virtual objects within the user's field of view. When a virtual object resembles with the given real-world object in shape or characteristics, the method is used to directly match the shape and size of the given real-world object. Therefore, the technical effect of superimposing the virtual object on the given real-world object when generating the mixed-reality image is to enhance visual consistency and precision in the virtual environment, providing the user with a realistic, immersive, and intuitive mixed-reality experience. The embedding of the virtual object relative to the given real-world object when generating the mixed-reality image involves placing the virtual object in a specific spatial relationship to the real-world object within the user's field of view. In an implementation, the embedding of the virtual object relative to the given real-world object when generating the mixed-reality image is based on the real-world object's location, orientation, and size. For example, a virtual object, such as a furniture could be embedded next to or on top of a real-world table, or a virtual object could be placed beside a real-world object in order to provide seamless blending between the virtual and real-world objects, making them appear as though they coexist naturally within the same space. As a result, the technical effect of embedding the virtual object relative to the given real-world object when generating the mixed-reality image is to process enhances the immersive experience of the user by allowing the virtual objects to interact meaningfully with the real-world environment. It also facilitates user interaction with both the virtual and real-world elements, enabling more intuitive and engaging mixed-reality experiences.

Furthermore, the term “depth-based occlusion effect” refers to a process of adjusting the visibility and layering of virtual and real-world objects within a mixed-reality environment based on their depth relative to the user. This effect ensures that objects closer to the user obscure those farther away, creating a more natural and realistic visual experience and also helps to maintain proper depth perception and visual consistency by ensuring that the virtual objects are appropriately obscured by the real-world objects. For example, the virtual objects can be placed behind real-world objects in terms of depth, or vice versa, depending on their distances from the user. Such realistic layering creates an enhanced visually consistent mixed reality environment, ensuring that the virtual objects appropriately blend with the real-world objects. The technical effect of applying the depth-based occlusion effect is to enhance the realism and immersion of the MR experience by accurately representing how objects should appear relative to one another based on their positions in the 3D space.

Furthermore, the term “inpainting pixels” refers to a process of digitally restoring or reconstructing missing or damaged parts of an image by using the surrounding visual information to fill in the gaps. Moreover, the inpainting of the pixels is used to address visual inconsistencies caused by self-occluding geometry in the real-world objects or any other visual anomalies. When a given real-world object has a self-occluding geometry and is being dis-occluded in the mixed-reality image, inpainting pixels can be performed to reconstruct missing parts of the real-world object. The inpainting pixels utilize the surrounding visual information to fill in any gaps or inconsistencies caused by the self-occlusion, ensuring a seamless blend between the virtual objects and the real-world objects in the MR environment. Moreover, the technical effect of inpainting the pixels is to seamlessly blend the virtual objects and the real-world objects, ensuring a smooth, consistent visual appearance and enhancing the overall quality and realism of the MR experience.

Furthermore, the term “auditing real-world objects in the real-world environment” refers to a process of examining and assessing the state and characteristics of the real-world objects present in a physical space, such as by identifying the position, size, shape, and other properties of the real-world objects. In an implementation, depth sensors and other scanning technologies can be used to perform auditing of the real-world objects. Moreover, the technical effect of auditing the real-world objects in the real-world environment is to enhance the visual consistency and realism in the mixed reality environment that leads to a more immersive and intuitive user experience. The term “virtual collision” is the simulated interaction between the real-world object and the virtual object within a mixed-reality (MR) environment. Moreover, by simulating the virtual collisions, the users can gain insights into potential effects of interactions between the real-world objects and the virtual objects. Additionally, such simulation of the virtual collisions can be further used for training, safety evaluations, and design testing, allowing the users to observe and analyze outcomes without any physical risk. For example, an engineer could simulate the collision of a real-world car with a virtual obstacle to test safety features, or a gamer could experience more immersive gameplay through realistic virtual collisions with real-world objects. Hence, the technical effect of utilizing the 3D model is used to allow for precise positioning and interaction of the virtual objects and real-time objects, resulting in higher-quality mixed-reality experiences that can be used for various applications, such as gaming, training, entertainment, simulations, and the like.

Optionally, the method further comprising:
receiving a first input indicative of a 3D point in the real-world environment at which an interaction element is pointing;
selecting a first real-world object from amongst the different real-world objects, based on a match between a 3D location of the first real-world object in the real-world environment and a location of the 3D point in the real-world environment; and
performing at least one of:
   (i) providing information indicative of at least one of: a 3D shape, the 3D location, a 3D orientation, a 3D size of the first real-world object;
   (ii) applying a first visual effect to a representation of the first real-world object in at least one of: the at least one image, at least one next image, based on at least one of: the 3D shape, the 3D location, the 3D orientation, the 3D size of the first real-world object, wherein the first visual effect pertains to at least one of: object selection, object tagging, object anchoring.

Throughout the present disclosure, the term “first input” refers to an initial piece of data or signal that indicates a specific 3D point in the real-world environment that can be represented by coordinates (x, y, z) at which the interaction element is pointing. In an implementation, the method is implemented by at least one processor, which receives the first input from a mixed-reality application (executing at a client device). In another implementation, the method can be implemented at the client device itself. In such a case, the first input will be received by the processor of the client device itself. In this regard, the term “interaction element” refers to a device that allows the user to interact with the real-world environment. Examples of the interaction element may include but are not limited to a user interface (UI) controller, a mouse, a joystick, a wearable device, or a gaze point that is determined by processing gaze-tracking data, which is collected by a gaze-tracking means, and the like. The first real-world object is selected based on the input received, for example, a chair, table, a living being, and the like, in order to identify a real-world object based on a specific 3D point to provide an accurate and precise object selection. In an implementation, the method includes providing information indicative of at least one of: a 3D shape, the 3D location, a 3D orientation, and a 3D size of the first real-world object. For example, the method includes providing information indicative of the 3D shape of the first real-world object. Similarly, the method includes providing information on the 3D location of the first real-world object. In another implementation, the method includes applying the first visual effect to a representation of the first real-world object in at least one of: the at least one image, at least one next image, based on at least one of: the 3D shape, the 3D location, the 3D orientation, the 3D size of the first real-world object. Moreover, the first visual effect pertains to at least one of: object selection, object tagging, and object anchoring. Examples of the first visual effect may include but are not limited to a highlighting, brightening, color adjustment, adding a visual cue pointing towards the representation, adding a visual tag to the representation, adding a chroma keying effect to the representation, and the like to the first real-world object. For example, the method includes applying the first visual effect to a representation of the first real-world object in the at least one image based on the 3D shape of the first real-world object. Similarly, the method includes applying the first visual effect to a representation of the first real-world object in the at least one image and the at least one next image based on the 3D size of the first real-world object. Moreover, the first visual effect pertains to at least one of: object selection, object tagging, and object anchoring. As a result, the technical effect of providing information on the 3D shape, the 3D location is to improve the user's understanding of the real-world object within the mixed-reality environment, aiding in precise interaction and manipulation. In addition, the provided information can be used to get metadata of the corresponding real-world object in order to get a detailed and comprehensive information (such as its material properties, function, or historical context) of the corresponding real-world object). The term “first visual effect” refers to a visual modification or enhancement applied to the representation of the first real-world object in images. In an implementation, the first visual effect pertains to the object selection. Moreover, the object selection refers to a process of identifying and choosing a specific real-world object within the virtual environment for further interaction or manipulation. In another implementation, the first visual effect pertains to the object tagging, which includes labelling or marking a specific real-world object within the virtual environment. In yet another implementation, the first visual effect pertains to the object anchoring. Moreover, the object anchoring refers to the fixing or stabilizing of a real-world object within a specific location or orientation in the virtual environment that is used to ensure consistency or maintain context in a mixed-reality experience. As a result, the technical effect of applying the first visual effect to a representation of the first real-world object in at least one of: the at least one image, at least one next image, based on at least one of: the 3D shape, the 3D location, the 3D orientation, the 3D size of the first real-world object is to allow precise selection and manipulation of the real-world object and provide an improved visualization of the real-time object in the mixed reality environment to improve the overall user experience.

Optionally, the method further comprising:
receiving a second input comprising a 3D model of a second real-world object that is to be searched in the at least one image;
extracting, from the 3D model of the second real-world object, a plurality of projections of the second real-world object from a perspective of different viewing directions;
searching the second real-world object in the at least one image, based on a comparison between the plurality of projections and at least one of: the 2D image masks of the set, the 3D shapes of the different real-world objects, the 3D orientations of the different real-world objects, the 3D sizes of the different real-world objects;
performing at least one of:
   (a) providing information indicative of an image segment of the at least one image that represents the second real-world object;
   (b) applying a second visual effect to a representation of the second real-world object in at least one of: the at least one image, at least one next image.

Herein, the term “second input” refers to an input of data that indicates a specific 3D point in the real-world environment that can be represented by coordinates (x, y, z) of the second real-world object. In an implementation, the method is implemented by at least one processor, which receives the first input from a mixed-reality application (executing at a client device). In another implementation, the method can be implemented at the client device itself. In such a case, the second input will be received by the processor of the client device itself. The extraction of the second real-world object from the 3D model by projecting the plurality of projections of the second real-world object from a perspective of different viewing directions. Furthermore, the searching of the second real-world object includes comparing the projections with various aspects of the real-world objects identified in the images, such as 2D image masks, 3D shapes, orientations, and sizes. Herein, the term “projections” refers to 2D representations of a 3D object as viewed from different perspectives or viewing directions. Moreover, such projections allow for the comparisons between the 3D model of the real-world object and images or other representations in the mixed-reality environment. The technical effect of extracting the plurality of projections from the 3D model of a second real-world object from different viewing directions is to enable comprehensive and accurate recognition of the object in images. Furthermore, based on the search results, the method either provides information about the second real-world object in the images or applies a second visual effect to its representation. In an implementation, the method includes providing information indicative of an image segment of the at least one image that represents the second real-world object. In another implementation, the method includes applying a second visual effect to a representation of the second real-world object in the at least one image. In yet another implementation, the method includes applying a second visual effect to a representation of the second real-world object in the at least one next image. For example, automotive customers that have virtual models (e.g., CAD model) can detect multiple real-world objects in the real-world environment by positioning the VR objects relative to the corresponding virtual objects. Moreover, the comparison between the plurality of projections and the at least one of the 2D image masks of the set, the 3D shapes of the different real-world objects are based on comparing the shapes and the features rather than comparing the sizes in order to recognize the structure and characteristics of the objects within the image. In addition, the size comparison can be conducted more accurately by using 3D data such as shapes, orientations, and sizes. This comparison leverages 3D modeling to capture precise information about the real-world object's dimensions and positions, enabling a more accurate and meaningful comparison between the virtual and real-world environments. The technical effect of searching for the second real-world object in at least one image based on the comparison between the plurality of projections and various aspects of the different real-world objects (such as 2D image masks, 3D shapes, orientations, and sizes) is to provide a precise and accurate object recognition and localization of the object within the image. As a result, the technical effect of providing information on the 3D shape, the 3D location is to improve the user's understanding of the second real-world object within the mixed-reality environment, aiding in precise interaction and manipulation. In addition, the provided information can be used to get metadata of the corresponding real-world object in order to get a detailed and comprehensive information (such as its material properties, function, or historical context) of the corresponding real-world object.

Furthermore, the term “second visual effect” refers to a visual modification or enhancement applied to the representation of the second real-world object in images. In an implementation, the second visual effect pertains to the object selection. Moreover, the object selection refers to a process of identifying and choosing a specific real-world object within the virtual environment for further interaction or manipulation. In another implementation, the second visual effect pertains to the object tagging, which includes labelling or marking a specific real-world object within the virtual environment. In yet another implementation, the second visual effect pertains to the object anchoring. Moreover, the object anchoring refers to the fixing or stabilizing of a real-world object within a specific location or orientation in the virtual environment that is used to ensure consistency or maintain context in a mixed-reality experience. Therefore, the technical effect of applying the second visual effect to a representation of the first real-world object in at least one of: the at least one image, at least one next image, based on at least one of: the 3D shape, the 3D location, the 3D orientation, the 3D size of the first real-world object is to allow precise selection and manipulation of the real-world object and provide an improved visualization of the real-time object in the mixed reality environment to improve the overall user experience.

Optionally, the step of searching the second real-world object comprises at least one of:
determining matches between a frontal shape of the second real-world object and the 2D image masks of the set;
determining matches between the plurality of projections and the 2D image masks of the set, across consecutive images captured from different poses of the at least one VST camera.

In this regard, the term “frontal shape” refers to a visual appearance of the second real-world object when viewed from the front. The method includes comparing the frontal shape of the second real-world object with the 2D image masks of the set that are further used to identify the real-time object in the images based on their distinct frontal appearance. After that, the method includes comparing the projections of the 3D model of the second real-world object with the 2D image masks across consecutive images to provide a comprehensive understanding of the object by considering different angles and perspectives. Finally, a series of images are taken one after another by the VST camera from different positions and angles to provide an enhanced view of the real-world environment and provide temporal coherency. Alternatively, a mixed reality (MR) application can be used to provide a model (e.g., a CAD model) of the first-real world object that the user likes to locate in the real-world environment. After that, various rotations of this object (specifically, RGB+D projections) are compared against the set of objects detected in the image and the best matches of these objects based on their 3D location, rotation and 3D size are returned back to the application. In an implementation, if the real-world object is detected only in a few frames, then its different rotations are no longer detected, leading to a false positive. In another implementation, different projections (or rotations) of the first real-world objects are compared against the 2D object mask. For example, in the case of an elevator, it is known to the user, which face of a particular component of the elevator would be facing a repair person. The technical effect of searching for the second real-world environment is to identify efficiently and accurately a specific second real-world object in images for multiple applications, such as augmented reality (AR) and virtual reality (VR), where precise object recognition is necessary for effective interaction and user experience.

Optionally, the method further comprising:
generating a list of at least a subset of the different real-world objects that are identified in the at least one image; and
providing information indicative of at least one of: a 3D shape, a 3D location, a 3D orientation, a 3D size, of each real-world object in said list.

In this regard, the generation of the list of at least the subset of the different real-world objects that are identified in the at least one image provides information about the 3D shape, 3D location, 3D orientation, and 3D size of each real-world object in the list. Moreover, such a list of at least the subset of the different real-world objects serves as a reference for further processing and manipulation. In addition, the information, such as the 3D shape, the 3D location, the 3D orientation, and the 3D size for each real-world object in the list, is further used for analysis purposes and further 3D modelling techniques. The technical effect of generating the list and providing the information about at least the subset of the different real-world objects allows for an enhanced comprehensive understanding of the real-world environment in order to facilitate interaction and manipulation within the 3D environment, leading to more efficient and effective mixed-reality experiences.

Optionally, the method further comprises selecting the subset of the different real-world objects that are identified in the at least one image, based on a given category of real-world objects.

In this regard, the term “category of real-world objects” refers to a classification or grouping of real-world objects based on certain attributes such as type, function, or other shared characteristics to filter and categorize the real-world objects identified in the image. For example, all chairs inside a room may be listed. The technical effect of selecting the subset of the different real-world objects that are identified in the at least one image is to allow targeted analysis and interaction with the relevant objects with an improved computational resource utilization and overall processing time, especially when dealing with complex or large datasets. In addition, by filtering the real-world objects based on the given category, the method is used to improve the focus and efficiency of subsequent tasks while providing an enhanced, customized user experience in mixed-reality applications.

Optionally, the method further comprising utilizing the list and the information to perform at least one of:
superimposing a virtual object on a given real-world object when generating a mixed-reality image,
embedding a virtual object relative to the given real-world object when generating the mixed-reality image,
marking at least one image segment representing at least one real-world object where VST content is to be shown in the mixed-reality image,
marking at least one other image segment representing at least one other real-world object where virtual content is to be shown in the mixed-reality image,
auditing real-world objects in the real-world environment,
simulating a virtual collision of a given real-world object with at least one virtual object in a sequence of mixed-reality images,
aligning coordinate spaces of a plurality of display apparatuses that are present in the real-world environment and that each comprises at least one VST camera,
applying a third visual effect to a virtual representation of at least one real-world object in the mixed-reality image.

In this regard, the term “superimposing of the virtual object” on the given real-world object when generating a mixed-reality image is used to provide a seamless integration of the virtual content with real-world objects, providing an immersive and interactive experience. In an implementation, a 3D virtual object may be superimposed on a 3D geometry of a real-world object. For example, a repair person wears an XR (extended reality) head-mounted display (HMD) device, allowing the repair person to view, detect, and highlight relevant real-world objects in the virtual environment, such as parts that need replacement or adjustment. Additionally, a set of instructions for the repair person can be provided through the VST. Moreover, the superimposition of the virtual object on the given real-world object allows for depth-based occlusion and disocclusion, providing accurate and enhanced knowledge of the 3D geometry of the real-world object. Additionally, such superimposition can also be used to measure and indicate the size, or the total area covered by the real-world objects in the room. In another example, if a user views a painting, the method is used to identify the painting and overlay information, such as the name of the artist, the year in which the painting was painted, and the like. As a result, the user's experience is improved by providing an additional information about the real-world objects that are viewed in the virtual reality environment. Additionally, the user can point towards a real-world object by highlighting it through a gaze or a controller to allow precise placement of the virtual objects either on or near the real-world object, creating a more seamless and integrated mixed-reality experience. Furthermore, a visual anchoring of the real-world objects is used to synchronize the virtual objects with the user's view of the real-world to ensure precise alignment of the virtual objects within the user's field of view. When a virtual object resembles with the given real-world object in shape or characteristics, the method is used to directly match the shape and size of the given real-world object. Therefore, the technical effect of superimposing the virtual object on the given real-world object when generating the mixed-reality image is to enhance visual consistency and precision in the virtual environment, providing the user with a realistic, immersive, and intuitive mixed-reality experience.

Furthermore, the embedding of the virtual object relative to the given real-world object when generating mixed-reality image involves placing the virtual object in a specific spatial relationship to the real-world object within the user's field of view. In an implementation, the embedding of the virtual object relative to the given real-world object when generating the mixed-reality image is based on the real-world object's location, orientation, and size. For example, a virtual object, such as a furniture could be embedded next to or on top of a real-world table, or a virtual object could be placed beside a real-world object in order to provide seamless blending between the virtual and real-world objects, making them appear as though they coexist naturally within the same space. As a result, the technical effect of embedding the virtual object relative to the given real-world object when generating the mixed-reality image is to process enhances the immersive experience of the user by allowing the virtual objects to interact meaningfully with the real-world environment. It also facilitates user interaction with both the virtual and real-world elements, enabling more intuitive and engaging mixed-reality experiences.

Furthermore, the term “marking” refers to a process of identifying the real-world objects within a mixed-reality image, such as by designating or highlighting the identified image segments representing at least one real-world object where VST content is to be shown in the mixes image, which could include overlays, annotations, and the like. The image segmentation is used to create the VST mask or a VR mask that can be further utilized to mark multiple real-world objects, such as a wall, a door, a ceiling on the area where the VST is visible. Alternatively, the image segmentation can also be used to mark real-world objects, such as a desktop, a keyboard, or displays as objects that should appear in the VST. The technical effect of marking the at least one image segment representing the at least one real-world object where VST content is to be shown in the mixed-reality image is to ensure that the VST content is appropriately positioned and displayed relative to the real-world objects thereby enhancing the user's augmented perception of their mixed-reality environment and providing valuable contextual information or visual enhancements. Additionally, the method further includes marking at least one other image segment representing at least one other real-world object where virtual content is to be shown in the mixed-reality image. This marking involves identifying specific areas or objects in the real-world environment where virtual content should be displayed. This includes selecting real-world objects, such as furniture, appliances, or other items and designating them as areas where virtual objects or information will be overlaid in the mixed-reality scene. The technical effect of marking the at least one other image segment representing the at least one other real-world object where virtual content is to be shown in the mixed-reality image is to place virtual content to enhance the user's experience and seamlessly integrate virtual elements into the real-world environment.

Furthermore, the term “auditing real-world objects in the real-world environment” refers to a process of examining and assessing the state and characteristics of the real-world objects present in a physical space, such as by identifying the position, size, shape, and other properties of the real-world objects. In an implementation, depth sensors and other scanning technologies can be used to perform auditing of the real-world objects. Moreover, the technical effect of auditing the real-world objects in the real-world environment is to enhance the visual consistency and realism in the mixed reality environment that leads to a more immersive and intuitive user experience. The term “simulating virtual collision” refers to the creation of a sequence where the virtual object collides with the real-world object that can be used to separate collisions for different objects, such as the virtual collision of the floor and a doll in medical training. Moreover, by simulating the virtual collisions, the users can gain insights into potential effects of interactions between the real-world objects and the virtual objects. Additionally, such simulation of the virtual collisions can be further used for training, safety evaluations, and design testing, allowing the users to observe and analyze outcomes without any physical risk. For example, an engineer could simulate the collision of a real-world car with a virtual obstacle to test safety features, or a gamer could experience more immersive gameplay through realistic virtual collisions with real-world objects.

Furthermore, the term “aligning coordinate space” refers to a process of ensuring consistency and synchronization among the tracking systems or play areas of multiple devices within the same physical space, such as head-mounted displays (HMDs) or other virtual reality devices. Additionally, the segmentation is used to align coordinate spaces of the plurality of multiple HMDs in the same space involves dividing the physical environment into distinct regions based on visual cues, allowing for accurate alignment and calibration of the tracking systems of multiple HMDs. The technical effect of aligning coordinate spaces of a plurality of display apparatuses that are present in the real-world environment and that each comprise at least one VST camera is to ensure that the virtual and real-world elements observed through different HMDs are properly aligned and coordinated, providing a cohesive mixed-reality experience for users across multiple devices.

Furthermore, the term “third visual effect” refers to a visual modification or enhancement applied to the representation of the real-world object in images. The application of the third visual effect to a virtual representation of at least one real-world object in the mixed-reality image involves enhancing or altering the visual appearance of selected objects using post-processing features in the VST environment. For example, users can mark specific objects, such as chairs, to increase their brightness, making them stand out more prominently in the scene. Alternatively, objects like scissors or items that pose a potential hazard, such as objects one might bump into, can be marked to appear in a bright red, drawing attention to them and increasing visibility for safety purposes. The technical effect of applying the third visual effect to the virtual representation of at least one real-world object in the mixed-reality image is to allow the users to customize the visual characteristics of individual objects within the mixed-reality environment to suit their preferences or address specific needs. As a result, he technical effect of utilizing the list and the information to perform marking, auditing, simulating, aligning, or applying third visual effect is to provide an advanced framework for integrating and managing virtual and real-world content, leading to a more immersive, precise, and visually appealing mixed-reality experience.

The present disclosure also relates to the second aspect as described above. Various embodiments and variants disclosed above, with respect to the aforementioned first aspect apply mutatis mutandis to the second aspect.

Throughout the present disclosure the term “pose-tracking means” refers to a specialized equipment that is employed to detect and/or follow the pose (namely, a position and orientation) of the image sensor within the real-world environment. In practice, the aforesaid pose-tracking means is employed to track a pose of the image sensor. Pursuant to embodiments of the present disclosure, the aforesaid pose-tracking means is implemented as a true Six Degrees of Freedom (6DoF) tracking system. In other words, said means track both the position and the orientation of the at least one camera within a three-dimensional (3D) space of the real-world environment, which is represented by the aforementioned global coordinate system. In particular, said pose-tracking means configured to track translational movements (namely, surge, heave, and sway movements) and rotational movements (namely, roll, pitch, and yaw movements) of the at least one camera within the 3D space.

In this regard, throughout the present disclosure, the term “at least one processor” refers to a processor that is configured to control an overall operation of the display apparatus and to implement the processing steps. Examples of implementation of the at least one of processor may include, but are not limited to, a central data processing device, a microprocessor, a microcontroller, a complex instruction set computing (CISC) processor, an application-specific integrated circuit (ASIC) processor, a reduced instruction set (RISC) processor, a very long instruction word (VLIW) processor, a state machine, and other processors or control circuitry. Optionally, the at least one of processor is communicably coupled to a display of the display apparatus. In some implementations, the processor of the display apparatus, through an application, is configured to render the one or more frames. In some implementations, the processor of the display apparatus, through the display, is configured to display the one or more rendered frames.

### DETAILED DESCRIPTION OF THE DRAWINGS

Referring to FIG. 1, illustrated are steps of a computer-implemented method for identification and segmentation of a three-dimensional (3D) object in video-see through (VST), in accordance with an embodiment of the present disclosure. The computer-implemented method is implemented by a system. At step 102, at least one image is captured using at least one video-see-through (VST) camera of a display apparatus. At step 104, a pose of the at least one VST camera is determined from which the at least one image is captured. At step 106, image segments in the at least one image that represent different real-world objects in a real-world environment are identified. At step 108, a set of two-dimensional (2D) image masks corresponding to the image segments representing the different real-world object is generated. Moreover, the given 2D image mask corresponds to a given real-world object. At step 110, the 2D image masks of the set onto a three-dimensional (3D) model of the real-world environment are projected digitally, from a perspective of the pose of the at least one VST camera, to determine at least one of: 3D shapes, 3D locations in the real-world environment, 3D orientations, 3D sizes, of the different real-world objects.

The aforementioned steps are only illustrative, and other alternatives can also be provided where one or more steps are added, one or more steps are removed, or one or more steps are provided in a different sequence without departing from the scope of the claims herein.

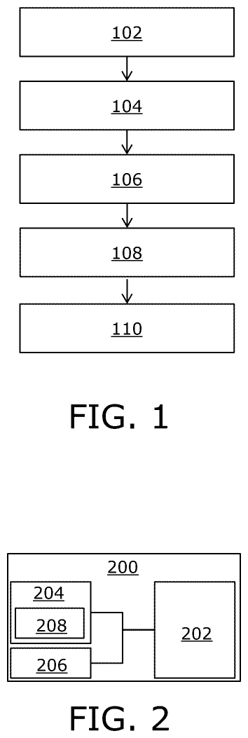

Referring to FIG. 2, illustrated is a block diagram of a system 200 configured for identification and segmentation of a three-dimensional (3D) object in video-see through (VST), in accordance with an embodiment of the present disclosure. The system 200 includes at least one processor (depicted as a processor 202). Optionally, the system 200 further comprises at least one video-see-through (VST) camera 208 arranged on a display apparatus 204, wherein the processor 202 is communicably coupled to the display apparatus 204. The processor 202 is configured to perform various operations as described earlier with respect to the aforementioned second aspect. The system 200 further includes a pose-tracking means 206 to determine a pose of the at least one VST camera 208 from which the at least one image is captured.

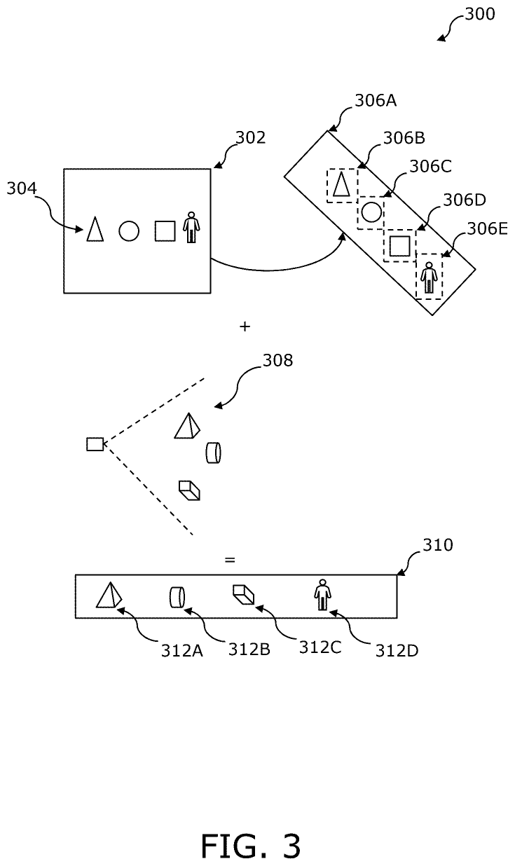

Referring to FIG. 3, illustrated is an exemplary diagram of events in the system 200 (of FIG. 2) for identification and segmentation of a three-dimensional (3D) object in video-see through (VST), in accordance with an embodiment of the present disclosure. The diagram 300 outlines the steps involved in identification and segmentation of the 3D object in the VST.

In an implementation, a set of two-dimensional (2D) image masks are generated through 2D segmentation are digitally projected onto a 3D model of the real-world environment for the determination of 3D shapes, 3D locations in the real-world environment, 3D orientations, 3D sizes, of the different real-world objects. In other words, the combination of the 2D image segmentation with the 3D geometry allows the creation of 3D models of the real-world objects within the mixed-reality environment. Firstly, at least one image 302 is captured using at least one video-see-through (VST) camera of the display apparatus 204 (of FIG. 2). Furthermore, the pose of the at least one VST camera is determined from which the at least one image is captured. After that, the image segments in the at least one image that represent different real-world objects 304 in the real-world environment are identified and a set 306 of two-dimensional (2D) image masks (including a first 2D image mask 306A, a second 2D image mask 306B, a third 2D image mask 306C, a fourth 2D image mask 306D, a fifth 2D image mask 306B, and the like) corresponding to the image segments representing the different real-world objects is generated. The 2D segmentation involves partitioning an image into 2D image segments based on visual characteristics such as color, texture, or brightness that is used to identify distinct objects or areas within the image. Moreover, the given 2D image mask corresponds to a given real-world object. Thereafter, the 2D image masks of the set is digitally projected onto a three-dimensional (3D) model 308 (e.g., a first 3D model of a first object, a second 3D model of a second model, and a third 3D model of a third model) of the real-world environment, from a perspective of the pose of the at least one VST camera, to determine at least one of: 3D shapes, 3D locations in the real-world environment, 3D orientations, 3D sizes, of the different real-world objects. The fusion of 2D image segmentation with 3D geometry allows for the creation of individual 3D objects with precise spatial attributes, including their position, orientation, size, and even color. Moreover, such integration facilitates the generation of detailed and realistic 3D models of the real-world objects within the mixed-reality environment. Additionally, an information 310 indicative of at least one of: a 3D shape, a 3D location, a 3D orientation, a 3D size, of each real-world object in said list is provided to ensure accurate and effective image identification and segmentation. For example, an information of a first real-world object 310A, an information of a second real-world object 310B, an information of a third real-world object 310C, an information of a fourth real-world object 310D, and the like. As a result, the user's experience is improved by providing an additional information about the real-world objects that are viewed in the virtual reality environment. In addition, the provided information can be used to get metadata of the corresponding real-world object in order to get a detailed and comprehensive information (such as its material properties, function, or historical context) of the corresponding real-world object).

FIG. 3 is merely an example, which should not unduly limit the scope of the claims herein. A person skilled in the art will recognize many variations, alternatives, and modifications of embodiments of the present disclosure.

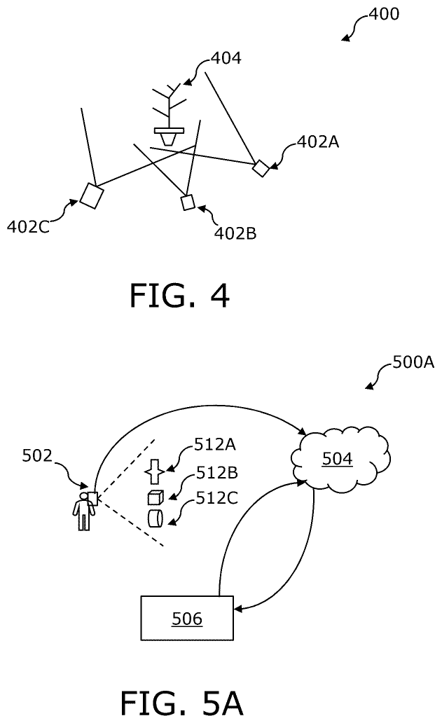

Referring to FIG. 4, illustrated is an exemplary diagram of a three-dimensional (3D) object fusion, in accordance with an embodiment of the present disclosure. The diagram 400 outlines the 3D object fusion in a virtual reality environment.

In an implementation scenario, head-mounted displays (HMDs), such as the first HMD 402A, second HMD 402B, and third HMD 402C are located on the display apparatus 204 in order to provide different viewpoints or perspectives of the object (referred to as a real-world object 404) within the mixed-reality environment. Moreover, by tracking the location of the object (i.e., an object 404) in 3D space from different views of the same object, a 3D model is generated by fusing all the different views. For example, multiple views of a single head mounted display (HMD), or views across multiple HMDs (e.g., a first HMD 402A, a second HMD 402B, and a third HMD 402C) can be fused together in order to obtain the 3D model. Optionally, different HMDs connected through a cloud-connected network or through a networked environment can be used to extract different views or representations that can be further fused rather than just different positions of a single HMD in order to obtain an accurate 3D model. Moreover, the combination of a color (i.e., red, green, and blue) and a depth (D) data (i.e., RGB+D) are fused together in order to obtain a water-tight 3D model of the object to allow an accurate and reliable extraction of the 3D model in the mixed-reality environment.

FIG. 4 is merely an example, which should not unduly limit the scope of the claims herein. A person skilled in the art will recognize many variations, alternatives, and modifications of embodiments of the present disclosure.

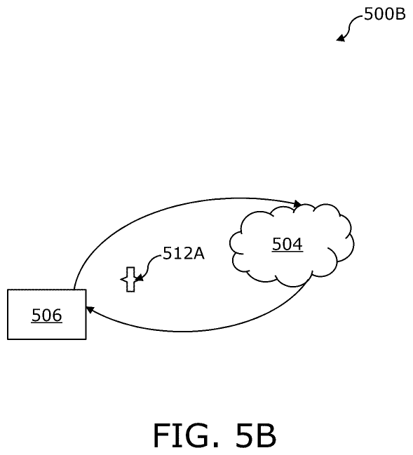

Referring to FIG. 5A, illustrated is an exemplary diagram of a Cloud-based architecture for identification and segmentation of a three-dimensional (3D) object in video-see through (VST), in accordance with an embodiment of the present disclosure. The diagram 500A outlines the steps involved in the cloud-based architecture for the identification and segmentation of the 3D object in the VST.

In an implementation scenario, 3D objects can be queried by an MR application 506 for any object selection or tagging purposes. Firstly, an XR HMD 502 is configured to capture a depth stream and a VST (video see-through) stream from the at least one VST camera. Thereafter, the captured VST stream and the depth stream are sent to a cloud network 504. The cloud network 504, upon receiving the VST stream and the depth stream, combines the VST stream with the depth stream to generate a 3D model to facilitate three dimensional (3D) reconstruction of the real-world objects, such as a first real-world object 512A, a second real-world object 512B, and a third real-world object 512C. Furthermore, the MR application 506 is configured to provide an information, such as 3D shapes, 3D locations, 3D orientations, 3D sizes of the real-world objects (e.g., the first real-world object 512A, the second real-world object 512B, and the third real-world object 512C) in the real-world environment. Furthermore, the MR application 506 is configured to access and interact with the identified 3D objects for selection and tagging purposes. As a result, an enhanced user interaction and manipulation within the mixed reality environment can be provided to the users thereby improving user experience and productivity.

FIG. 5A is merely an example, which should not unduly limit the scope of the claims herein. A person skilled in the art will recognize many variations, alternatives, and modifications of embodiments of the present disclosure.

Referring to FIG. 5B, illustrated is another exemplary diagram of a Cloud-based architecture for identification and segmentation of a three-dimensional (3D) object in video-see through (VST), in accordance with an embodiment of the present disclosure. The diagram 500B outlines the steps involved in the cloud-based architecture for the identification and segmentation of the 3D object in the VST.

In an implementation scenario, the mixed-reality (MR) application 506 is configured to request the cloud network 504 to locate the real-world object 512A, along with a 3D model (e.g., a CAD model). The cloud network 504, upon receiving the request from the MR application 506 to find the real-world object 512A in the mixed-reality environment, returns the 3D location and the 3D orientation of the real-world object 512A. The cloud network 504 is configured to compare different rotations of the real-world object 512A (RGB+D projections of the real-world object 512A) with the set of real-world objects that are detected in the mixed-reality image. Thereafter, the best match of the real-world object 512A, such as the same 3D location, 3D rotation and the 3D size, are provided to the MR application 506. As a result, by observing a real-world object match across multiple frames with varying rotations, the method is used to identify the real-world objects (e.g. the real-world object 512A) with enhanced accuracy, reliability, and efficiency.

FIG. 5B is merely an example, which should not unduly limit the scope of the claims herein. A person skilled in the art will recognize many variations, alternatives, and modifications of embodiments of the present disclosure.

1. A computer-implemented method comprising:
capturing at least one image using at least one video-see-through camera of a display apparatus;
determining a pose of the at least one VST camera from which the at least one image is captured;
identifying image segments in the at least one image that represent different real-world objects in a real-world environment;
generating a set of two-dimensional image masks corresponding to the image segments representing the different real-world objects, wherein a given 2D image mask corresponds to a given real-world object; and
digitally projecting the 2D image masks of the set onto a three-dimensional model of the real-world environment, from a perspective of the pose of the at least one VST camera, to determine at least one of: 3D shapes, 3D locations in the real-world environment, 3D orientations, 3D sizes, of the different real-world objects.

2. The method of claim 1, wherein the at least one image comprises a plurality of images that are captured from different poses of the at least one VST camera, the method further comprising:
determining whether at least a subset of the plurality of images have image segments that represent a given real-world object, based on a 3D location of the given real-world object in the real-world environment;
when it is determined that at least the subset of the plurality of images have the image segments that represent the given real-world object, fusing together the image segments that represent the given real-world object to generate a 3D model of the given real-world object.

3. The method of claim 2, further comprising utilizing the 3D model of the given real-world object to perform at least one of:
superimposing a virtual object on the given real-world object when generating a mixed-reality image,
embedding a virtual object relative to the given real-world object when generating the mixed-reality image,
applying a depth-based occlusion effect when generating the mixed-reality image,
inpainting pixels when the given real-world object has a self-occluding geometry and is being dis-occluded in the mixed-reality image,
auditing real-world objects in the real-world environment,
simulating a virtual collision of the given real-world object with at least one virtual object in a sequence of mixed-reality images.

4. The method of claim 1, further comprising:
receiving a first input indicative of a 3D point in the real-world environment at which an interaction element is pointing;
selecting a first real-world object from amongst the different real-world objects, based on a match between a 3D location of the first real-world object in the real-world environment and a location of the 3D point in the real-world environment; and
performing at least one of:
(i) providing information indicative of at least one of: a 3D shape, the 3D location, a 3D orientation, a 3D size of the first real-world object;
(ii) applying a first visual effect to a representation of the first real-world object in at least one of: the at least one image, at least one next image, based on at least one of: the 3D shape, the 3D location, the 3D orientation, the 3D size of the first real-world object, wherein the first visual effect pertains to at least one of: object selection, object tagging, object anchoring.

5. The method of claim 1, further comprising:
receiving a second input comprising a 3D model of a second real-world object that is to be searched in the at least one image;
extracting, from the 3D model of the second real-world object, a plurality of projections of the second real-world object from a perspective of different viewing directions;
searching the second real-world object in the at least one image, based on a comparison between the plurality of projections and at least one of: the 2D image masks of the set, the 3D shapes of the different real-world objects, the 3D orientations of the different real-world objects, the 3D sizes of the different real-world objects;
performing at least one of:
(a) providing information indicative of an image segment of the at least one image that represents the second real-world object;
(b) applying a second visual effect to a representation of the second real-world object in at least one of: the at least one image, at least one next image.

6. The method of claim 5, wherein the step of searching the second real-world object comprises at least one of:
determining matches between a frontal shape of the second real-world object and the 2D image masks of the set;
determining matches between the plurality of projections and the 2D image masks of the set, across consecutive images captured from different poses of the at least one VST camera.

7. The method of claim 1, further comprising:
generating a list of at least a subset of the different real-world objects that are identified in the at least one image; and
providing information indicative of at least one of: a 3D shape, a 3D location, a 3D orientation, a 3D size, of each real-world object in said list.

8. The method of claim 7, further comprising selecting the subset of the different real-world objects that are identified in the at least one image, based on a given category of real-world objects.

9. The method of claim 7, further comprising utilizing the list and the information to perform at least one of:
superimposing a virtual object on a given real-world object when generating a mixed-reality image,
embedding a virtual object relative to the given real-world object when generating the mixed-reality image,
marking at least one image segment representing at least one real-world object where VST content is to be shown in the mixed-reality image,
marking at least one other image segment representing at least one other real-world object where virtual content is to be shown in the mixed-reality image,
auditing real-world objects in the real-world environment,
simulating a virtual collision of a given real-world object with at least one virtual object in a sequence of mixed-reality images,
aligning coordinate spaces of a plurality of display apparatuses that are present in the real-world environment and that each comprise at least one VST camera,
applying a third visual effect to a virtual representation of at least one real-world object in the mixed-reality image.

10. A system comprising:
at least one video-see-through camera arranged on a display apparatus;
a pose-tracking means; and
at least one processor configured to:
capture at least one image using the at least one VST camera;
determine a pose of the at least one VST camera from which the at least one image is captured, using the pose-tracking means;
identify image segments in the at least one image that represent different real-world objects in a real-world environment;
generate a set of two-dimensional (2D) image masks corresponding to the image segments representing the different real-world objects, wherein a given 2D image mask corresponds to a given real-world object; and
digitally project the 2D image masks of the set onto a three-dimensional (3D) model of the real-world environment, from a perspective of the pose of the at least one VST camera, to determine at least one of: 3D shapes, 3D locations in the real-world environment, 3D orientations, 3D sizes, of the different real-world objects.

11. The system of claim 10, wherein the at least one image comprises a plurality of images that are captured from different poses of the at least one VST camera, the system is further configured to:
determine whether at least a subset of the plurality of images have image segments that represent a given real-world object, based on a 3D location of the given real-world object in the real-world environment;
when it is determined that at least the subset of the plurality of images have the image segments that represent the given real-world object, fusing together the image segments that represent the given real-world object to generate a 3D model of the given real-world object.

12. The system of claim 10, is further configured to:
receive a first input indicative of a 3D point in the real-world environment at which an interaction element is pointing;
select a first real-world object from amongst the different real-world objects, based on a match between a 3D location of the first real-world object in the real-world environment and a location of the 3D point in the real-world environment; and
perform at least one of:
(i) provide information indicative of at least one of: a 3D shape, the 3D location, a 3D orientation, a 3D size of the first real-world object;
(ii) apply a first visual effect to a representation of the first real-world object in at least one of: the at least one image, at least one next image, based on at least one of: the 3D shape, the 3D location, the 3D orientation, the 3D size of the first real-world object, wherein the first visual effect pertains to at least one of: object selection, object tagging, object anchoring.

13. The system of claim 10, is further configured to:
receive a second input comprising a 3D model of a second real-world object that is to be searched in the at least one image;
extract, from the 3D model of the second real-world object, a plurality of projections of the second real-world object from a perspective of different viewing directions;
search the second real-world object in the at least one image, based on a comparison between the plurality of projections and at least one of: the 2D image masks of the set, the 3D shapes of the different real-world objects, the 3D orientations of the different real-world objects, the 3D sizes of the different real-world objects;
perform at least one of:
(a) provide information indicative of an image segment of the at least one image that represents the second real-world object;
(b) apply a second visual effect to a representation of the second real-world object in at least one of: the at least one image, at least one next image.

14. The system of claim 10, is further configured:
generate a list of at least a subset of the different real-world objects that are identified in the at least one image; and
provide information indicative of at least one of: a 3D shape, a 3D location, a 3D orientation, a 3D size, of each real-world object in said list.
